(19) United States
(12) Patent Application Publication
(10) Pub. No.: US 2011/0183147 A1
(43) Pub. Date: Jul. 28, 2011

(54) Method for Functionalising a Textile Substrate in Order to Impart Humidity Transfer Properties Thereto

(75) Inventors: Claudine Colin, Charly (FR); Guilhem Merenna, Lyon (FR)

(73) Assignee: LAINIERE DE PICARDIE BC, Peronne Cedex (FR)

(21) Appl. No.: 13/063,794

(22) PCT Filed: Sep. 15, 2009
(86) PCT No.: PCT/FR2009/001097

§ 371 Date: Mar. 14, 2011

(30) Foreign Application Priority Data
Sep. 17, 2008 (FR) 0805121

(51) Int. Cl. B32B 9/04; D06M 23/16; B32B 23/04

(52) U.S. Cl. 428/447; 8/116.1; 428/532

(57) ABSTRACT

A method for functionalising a textile substrate made of a hydrophilic material in order to impart humidity transfer properties thereto, wherein the method includes the steps of: preparing a formulation of at least one hydrophobic material containing at least one group reacting under ionising radiation; forming a discontinuous layer using the formulation on a surface of the textile substrate; and applying an ionising radiation onto the discontinuous layer in order to graft the hydrophobic material on the surface of the substrate by the reaction of the reactive groups.

### BACKGROUND

The invention relates to a method for functionalising a textile substrate based on a hydrophilic material in order to impart humidity transfer properties thereto, and a textile substrate functionalised by implementing such a method.

In particular, a textile substrate according to the invention enables the making of clothing to be worn in contact with skin, such as underwear, polo shirts, T-shirts, shirts, etc.

Indeed, particularly with textile substrates based on hydrophilic material, perspiration may be stored in contact with skin, giving rise to considerable discomfort. For this reason, particularly in such applications, humidity transfer properties are sought to facilitate the discharge of the perspiration outside the item of clothing.

A textile substrate according to the invention is thus particularly suitable for making sportswear type clothing for which wet contact is particularly present as the user perspires during the effort induced by physical activity.

In order to give a textile substrate humidity transfer properties, a method using a hydrophilic layer and a hydrophobic layer deposited respectively on a surface of the substrate is known, particularly from the document U.S. 2007/0151039.

However, the deposited layers according to this document are continuous, which hampers the flexibility and breathability of the textile substrate. Consequently, the comfort, particular thermal comfort, of an item of clothing made with such a textile substrate is not satisfactory, particularly in that the calories produced by the user cannot be transferred outside effectively.

### SUMMARY OF THE INVENTION

The aim of the invention is that of perfecting the prior art by providing a method for functionalising a textile substrate wherein the humidity transfer properties are combined with satisfactory breathability, so as to promote the transfer to the outside of both the perspiration and calories produced by the user of an item of clothing made with said substrate. In this way, humidity transfer is used suitably to facilitate the discharge of calories.

For this purpose, and according to a first aspect, the invention relates to a method for functionalising a textile substrate based on a hydrophilic material in order to impart humidity transfer properties thereto, said method comprising steps consisting of:
preparing a formulation of at least one hydrophobic material comprising at least one reactive group in ionising radiation;
forming with said formulation a discontinuous layer on a surface of the textile substrate;
applying ionising radiation on said discontinuous layer so as to graft the hydrophobic material onto the surface of the substrate by reacting the reactive groups.

According to a second aspect, the invention relates to a textile substrate functionalised by implementing such a method, said substrate being based on a hydrophilic material and the inner surface thereof being grafted with a discontinuous layer of a hydrophobic material, said discontinuous layer being partially impregnated in said surface so as to create a hydrophilic-hydrophobic gradient in order to impart to said substrate humidity transfer properties in the thickness thereof.

Further specificities and advantages of the invention will emerge in the description of various particular embodiments hereinafter.

### DETAILED DESCRIPTION OF THE PREFERRED EMBODIMENT(S)

A method for functionalising a textile substrate based on a hydrophilic material in order to impart humidity transfer properties thereto is described hereinafter. In particular, the material acting as the textile substrate may be chosen from cellulose derivatives, particularly cotton and/or viscose, or polycottons mainly consisting of cellulose derivatives mixed with a lesser quantity of synthetic fibres.

The textile substrate may take any suitable form for making clothing, particularly consisting of a knit, woven or non-woven fabric sheet. Furthermore, the textile substrate may undergo, prior to the functionalising thereof, particular treatments, particularly to improve the cohesion and/or wettability thereof.

The textile substrate is more specifically intended for making clothing to be worn in contact with the skin, particularly sportswear type clothing. In particular, the entire item of clothing may be made with at least one functionalised textile substrate according to the invention, or the use of the functionalised substrate may be restricted to the areas of the clothing in more specific need of humidity transfer properties.

The method for functionalising envisages preparing a formulation of at least one hydrophobic material, i.e. having at least hydrophilic properties that are inferior to that of the material acting as the textile substrate. Furthermore, the hydrophobic material comprises at least one reactive group in ionising radiation. In particular, such groups may comprise an unsaturated bond which, under the effect of ionising radiation, forms a reactive free radical. For example, the reactive group in ionising radiation may be chosen from the vinyl, amine, epoxy, acrylate, hydroxyl, phenyl, ether, ester, carboxyl groups.

According to one embodiment, the formulation comprises polydimethyl siloxane (PDMS) chains, particularly PDMS chains of various lengths. Indeed, these chains make it possible, after cross-linking, to form a material based on silicone elastomer which, besides the hydrophobic properties thereof, is naturally soft, flexible, compatible with skin and hypoallergenic.

In particular, the PDMS chains comprise, along said chain, functional groups which are reactive in ionising radiation. In this way, by applying such radiation, it is possible to crosslink said chains together and/or with a further reactive material such as for example di- or tri-functional agents or a textile substrate also having reactive functions in ionising radiation.

According to one embodiment, the formulation comprises an oil or a mixture of oils comprising PDMS chains. In particular, the formulation may comprise a mixture of at least one oil comprising functionalised PDMS chains and/or one or a plurality of oils comprising non-functionalised PDMS chains.

The method for functionalising envisages forming with said formulation a discontinuous layer on a surface of the textile substrate. For this purpose, a lattice of discontinuous structural units, particularly dots, may be deposited on the surface of the textile substrate, particularly by means of screen printing, etching, spraying, ink jet, lithography, transfer.

In an alternative embodiment, the discontinuous layer may be formed by depositing a continuous layer of the formulation on the surface of the textile substrate, and by treating said layer to render same discontinuous. In particular, the continuous layer may be deposited by transfer and stretched mechanically to render same discontinuous by crazing said continuous layer. Furthermore, additives suitable for promoting the creation of porosity and/or discontinuity in said layer may be added to the formulation of the layer.

The formulation may be arranged to promote the impregnation of the surface of the textile substrate by the discontinuous layer formed, particularly by including a wetting agent. Furthermore, the formulation may comprise further additives such as rheological or thixotropic agents but also resins, gums, adherence promoters or reagent compounds including SiH groups.

The formulation may be prepared using at least one oil, pure, in emulsion or in dispersion. A typical example of a formulation may comprise the following mixture:
between 5 and 50% non-functionalised PDMS oils;
between 5 and 50% functionalised PDMS oils with vinyl groups;
between 5 and 50% functionalised PDMS oils with acrylate groups;
between 2 and 20% of a cross-linking resin;
between 0.3% and 3% of an adherence promoter.

A further example of a formulation is a mixture of this type which is emulsified in an aqueous part between 35 and 85%. Both parts may be bound using surfactants and emulsifiers (between 0.5 and 5%). The rheology may be adjusted by means of a thixotropic agent such as polyurethane (between 0.2 and 2%), and the wettability on the substrate by adding a wetting agent (between 0.3 and 3%).

The method for functionalising envisages applying ionising radiation on the discontinuous layer so as to graft the hydrophobic material on the surface of the substrate by reacting the reactive groups. According to one embodiment, the ionising radiation is an electron bombardment generated by an electron accelerator which, in the case of the use of PDMS chains, is adjusted in respect of power and time to enable the cross-linking and grafting of said chains.

The method may further envisage a heat treatment step of the formed and/or grafted discontinuous layer, for example by means of infrared lamps, so as to dry the textile substrate. The heat treatment may further enable heat-fixing of the formulation on the textile substrate.

Finally, the textile substrate may be washed and dried or undergo further treatments required for the subsequent use thereof.

According to one embodiment, the formulation further comprises microcapsules containing an active composition in a casing, said casing being based on a material comprising at least one reactive group in ionising radiation. In this way, when the ionising radiation is applied, the microcapsules are grafted on the surface of the substrate so as to be able to combine the humidity transfer properties with those of the active composition. According to one embodiment, the discontinuous layer may be in the form of a porous foam, the microcapsules being suitable for integration is said pores.

In particular, the active substance may be suitable for providing the textile substrate with heat regulation properties, particularly by integrating a phase change material wherein the melting point is between 15° C. and 38° C., preferably between 22° C. and 35° C., so as to conduct heat regulation close to the human body temperature.

In other applications, the active substance may have further properties, for example in respect of hygiene or comfort. In some embodiments, the active substance may comprise essential oils particularly to improve breathing, fragrances, repellents, particularly against mosquitoes, conductive or antistatic charges, bacteriostatic agents such as silver salts, deodorisers.

According to one embodiment, the formulation may further comprise a cross-linking agent having at least one reactive group in ionising radiation. In particular, two- or three-reagent cross-linking agents may be used, particularly chosen in the group including glycidyl acrylate or methacrylate (AGLY, MAGLY), polyethylene glycol 200, 400, 600 diacrylate (PEG200 DA, PEG400 DA, PEG600 DA), dipropylene glycol diacrylate (DPGA), potassium sulphopropyl methacrylate (SPMK) and lauryl methacrylate or acrylate. The cross-linking agents also include hybrid organometallic compounds, organosilanes or organotitanates binding with silicone compounds or mineral fillers and comprising reactive functional groups in ionising radiation enabling cross-linking with organic compounds. These families of constituents particularly include compounds such as MEMO (Methacryloxypropyltrimethoxysilane), GLYMO (Glycidopropyltrimethoxysilane), VTMO (Vinyl TriMetOxy silane), PTMO (Propyltrimethoxysilane) and TBOT (Tetrabutylorthotitanate).

In this way, the reactions between the reactive groups and the cross-linking agents bind the hydrophobic material, any microcapsules and the fibres of the textile substrate, so as to create a solid three-dimensional lattice that is resistant to friction and washing or dry cleaning.

The method according to the invention makes it possible to produce a substrate based on a hydrophilic material wherein the inner surface is grafted with a discontinuous layer of a hydrophobic material, particularly a material based on silicone elastomer. In this way, the textile substrate remains breathable, particularly via the discontinuities of the layer, so as to prevent a sweating-room effect. For example, the discontinuous layer coverage rate may be between 30 and 70% and the weight thereof between 1 and 50 g/m², particularly between 5 and 15 g/m².

Furthermore, the discontinuous layer is partially impregnated in the surface so as to create a hydrophilic-hydrophobic gradient with a view to giving said substrate humidity transfer properties from the inside to the outside of the clothing.

In this way, the hydrophilic-hydrophobic gradient may be adjusted to manage the humidity transfer kinetics so as to promote the natural migration of the humidity in the thickness of the substrate from the inner surface thereof to the outer surface thereof, and thus the discharge thereof from the skin to the outside of the clothing.

Furthermore, the discontinuous layer may be formed on a raised surface in relation to the inner surface so as to be inserted between said surface and the skin of a user of an item of clothing made with said substrate. In this way, besides the humidity transfer and breathability functions, the discontinuous layer will be able to act as a barrier between the skin and the substrate impregnated with perspiration and thus improve the comfort of use.

Moreover, the grafting and optional cross-linking of the hydrophobic material on the textile substrate is particularly durable with, in particular, a high washing machine resistance of the discontinuous layer.

1-17. (canceled)

18. Method for functionalising a textile substrate based on a hydrophilic material in order to impart humidity transfer properties thereto, said method comprising the steps of:
preparing a formulation of at least one hydrophobic material comprising at least one reactive group in ionising radiation;
forming with said formulation a discontinuous layer on a surface of the textile substrate; and
applying ionising radiation on said discontinuous layer so as to graft the at least one hydrophobic material onto the surface of the substrate by reacting the reactive groups.

19. Method for functionalising according to claim 18, further comprising arranging the formulation so as to promote impregnation of the surface of the textile substrate with the discontinuous layer formed.

20. Method for functionalising according to claim 18, wherein the discontinuous layer is formed on a raised surface in relation to an inner surface of the textile substrate.

21. Method for functionalising according to claim 18, wherein the formulation comprises polydimethyl siloxane (PDMS) chains, and said chains being cross-linked and grafted during application of the ionising radiation.

22. Method for functionalising according to claim 21, further comprising grafting at least one type of reactive group in ionising radiation of said PDMS chains.

23. Method for functionalising according to claim 21, further comprising preparing the formulation using at least one PDMS chain oil, pure, in emulsion or in dispersion.

24. Method for functionalising according to claim 21, wherein the formulation comprises a mixture of oils comprising PDMS chains.

25. Method for functionalising according to claim 18, wherein the reactive group in ionising radiation is chosen from vinyl, amine, epoxy, acrylate, hydroxyl, phenyl, ether, ester, carboxyl groups.

26. Method for functionalising according to claim 18, wherein the discontinuous layer is formed by depositing a lattice of discontinuous structural units on the surface of the textile substrate.

27. Method for functionalising according to claim 18, wherein the discontinuous layer is formed by depositing a continuous layer of the formulation on the surface of the textile substrate, and by treating said continuous layer to render same discontinuous.

28. Method for functionalising according to claim 18, wherein the formulation further comprises microcapsules containing an active composition in a casing, and said casing being based on a material comprising at least one reactive group in ionising radiation.

29. Method for functionalising according to claim 18, wherein the formulation further comprises at least one cross-linking agent having at least one reactive group in ionising radiation.

30. Method for functionalising according to claim 18, further comprising a heat treatment step of the discontinuous layer.

31. Method for functionalising according to claim 18, wherein the ionising radiation is an electron bombardment.

32. Textile substrate functionalised by implementing a method according to claim 1, said substrate being based on a hydrophilic material and an inner surface thereof being grafted with a discontinuous layer of a hydrophobic material, said discontinuous layer being partially impregnated in said surface so as to create a hydrophilic-hydrophobic gradient in order to impart to said substrate humidity transfer properties in the thickness thereof.

33. Textile substrate according to claim 32, wherein the hydrophobic material is based on a silicone elastomer.

34. Textile substrate according to claim 32, wherein the textile substrate is based on at least one of cellulose derivatives and polycottons.
